(19) United States
(12) Patent Application Publication
(10) Pub. No.: US 2012/0130717 A1
(43) Pub. Date: May 24, 2012

(54) Real-time Animation for an Expressive Avatar

(75) Inventors: Ning Xu, Bejjing (CN); Lijuan Wang, Beijing (CN); Frank Kao-Ping Soong, Beijing (CN); Xiao Liang, Beijing (CN); Qi Luo, Beijing (CN); Ying-Qing Xu, Beijing (CN); Xin Zou, Beijing (CN)

(73) Assignee: Microsoft Corporation, Redmond, WA (US)

(21) Appl. No.: 12/950,801

(22) Filed: Nov. 19, 2010

(51) Int. Cl. G10L 13/00; G06T 13/00

(52) U.S. Cl. 704/258; 345/473

(57) ABSTRACT

Techniques for providing real-time animation for a personalized cartoon avatar are described. In one example, a process trains one or more animated models to provide a set of probabilistic motions of one or more upper body parts based on speech and motion data. The process links one or more predetermined phrases that represent emotional states to the one or more animated models. After creation of the models, the process receives real-time speech input. Next, the process identifies an emotional state to be expressed based on the one or more predetermined phrases matching in context to the real-time speech input. The process then generates an animated sequence of motions of the one or more upper body parts by applying the one or more animated models in response to the real-time speech input.

### BACKGROUND

An avatar is a representation of a person in a cartoon-like image or other type of character having human characteristics. Computer graphics present the avatar as two-dimensional icons or three-dimensional models, depending on an application scenario or a computing device that provides an output. Computer graphics and animations create moving images of the avatar on a display of the computing device. Applications using avatars include social networks, instant-messaging programs, videos, games, and the like. In some applications, the avatars are animated by using a sequence of multiple images that are replayed repeatedly. In another example, such as instant-messaging programs, an avatar represents a user and speaks aloud as the user inputs text in a chat window.

In some of these and other applications, the user communicates moods to another user by using textual emoticons or “smilies.” Emoticons are textual expressions (e.g., :-)) and “smilies” are representations of a human face (e.g., [symbol] ). The emoticons and smilies represent moods or facial expressions of the user during communication. The emoticons alert a responder to a mood or a temperament of a statement, and are often used to change and to improve interpretation of plain text.

However, problems exist with being able to use the emoticons and smilies. Many times, the user types in the emoticons or smilies after the other user has already read the text associated with the expressed emotion. In addition, there may be circumstances where the user forgets to type the emoticons or smilies. Thus, it becomes difficult to communicate accurately a user's emotion through smilies or text of the avatar.

### SUMMARY

This disclosure describes an avatar that expresses emotional states of the user based on real-time speech input. The avatar displays emotional states with realistic facial expressions synchronized with movements of facial features, head, and shoulders.

In an implementation, a process trains one or more animated models to provide a set of probabilistic motions of one or more upper body parts based on speech and motion data. The process links one or more predetermined phrases of emotional states to the one or more animated models. The process then receives real-time speech input from a user and identifies an emotional state of the user based on the one more predetermined phrases matching in context to the real-time speech input. The process may then generate an animated sequence of motions of the one or more upper body parts by applying the one or more animated models in response to the real-time speech input.

In another implementation, a process creates one or more animated models to identify probabilistic motions of one or more upper body parts based on speech and motion data. The process associates one or more predetermined phrases of emotional states to the one or more animated models.

This Summary is provided to introduce a selection of concepts in a simplified form that are further described below in the Detailed Description. This

Summary is not intended to identify key features or essential features of the claimed subject matter, nor is it intended to be used to limit the scope of the claimed subject matter.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example architecture for presenting an expressive avatar.

FIG. 2 is a flowchart showing illustrative phases for providing the expressive avatar for use by the architecture of FIG. 1.

FIG. 3 is a flowchart showing an illustrative process of creating a personalized avatar comprising an animated representation of an individual.

FIG. 4 is a flowchart showing an illustrative process of creating and training an animated model.

FIG. 5 illustrates examples showing the markers on a face to record movement.

FIG. 6 is a flowchart showing an illustrative process of providing a sequence of animated synthesis in response to real-time speech input.

FIG. 7 is a flowchart showing an illustrative process of mapping three-dimensional (3D) motion trajectories to a two-dimensional (2D) cartoon avatar and providing a real-time animation of the personalized avatar.

FIG. 8 illustrates examples of markers on a face to record movement in 2D and various emotional states expressed by an avatar.

FIG. 9 is a block diagram showing an illustrative server usable with the architecture of FIG. 1.

### DETAILED DESCRIPTION

### Overview

This disclosure describes an architecture and techniques for providing an expressive avatar for various applications. For instance, the techniques described below may allow a user to represent himself or herself as an avatar in some applications, such as chat applications, game applications, social network applications, and the like. Furthermore, the techniques may enable the avatar to express a range of emotional states with realistic facial expressions, lip synchronization, and head movements to communicate in a more interactive manner with another user. In some instances, the expressed emotional states may correspond to emotional states being expressed by the user. For example, the user, through the avatar, may express feelings of happiness while inputting text into an application, in response, the avatar's lips may turn up at the corners to show the mouth of the avatar smiling while speaking. By animating the avatar in this manner, the other user that views the avatar is more likely to respond accordingly based on the avatar's visual appearance. Stated otherwise, the expressive avatar may be able to represent the user's mood to the other user, which may result in a more fruitful and interactive communication.

An avatar application may generate an expressive avatar described above. To do so, the avatar application creates and trains animated models to provide speech and body animation synthesis. Once the animated models are complete, the avatar application links predetermined phrases representing emotional states to be expressed to the animated models. For instance, the phrases may represent emotions that are commonly identified with certain words in the phrases. Furthermore, specific facial expressions are associated with particular emotions. For example, the certain words in the predetermined phrases may include “married” and “a baby” to represent an emotional state of happiness. In some instances, the phrases “My mother or father has passed away” and “I lost my dog or cat” have certain words in the phrases, such as “passed away” and “lost,” that are commonly associated with an emotional state of sadness. Other certain words, such as “mad” or “hate,” are commonly associated with an emotional state of anger. Thus, the avatar responds with specific facial expressions to each of the emotional states of happiness, sadness, anger, and so forth. After identifying one of these phrases that are associated with a certain emotion, the avatar application then applies the animated models along with the predetermined phrases to provide the expressive avatar. That is, the expressive avatar may make facial expressions with behavior that is representative of the emotional states of the user. For instance, the expressive avatar may convey these emotional states through facial expressions, lip synchronization, and movements of the head and shoulders of the avatar.

In some instances, the animated model analyzes relationships between speech and motion of upper body parts. The speech may be text, live speech, or recorded speech that is synchronized with motion of the upper body parts. The upper body parts include a head, a full face, and shoulders.

The avatar application receives real-time speech input and synthesizes an animated sequence of motion of the upper body parts by applying the animated model. Typically, the term “real-time” is defined as producing or rendering an image substantially at the same time as receiving the input. Here, “real-time” indicates receiving the real-time input to process real-time based animated synthesis for producing real-time animation with facial expressions, lip-synchronization, and head/shoulder movements.

Furthermore, the avatar application identifies the predetermined phrases often used to represent basic emotions. Some of the basic emotional states that may be expressed include neutral, happiness, fear, anger, surprise, and sadness. The avatar application associates an emotional state to be expressed through an animated sequence of motion of the upper body parts. The avatar application activates the emotional state to be expressed when the one or more predetermined phrases matches or is about the same context as the real-time speech input.

A variety of applications may use the expressive avatar. The expressive avatar may be referred to as a digital avatar, a cartoon character, or a computer-generated character that exhibits human characteristics. The various applications using the avatar include but are not limited to, instant-messaging programs, social networks, video or online games, cartoons, television programs, movies, videos, virtual worlds, and the like. For example, an instant-messaging program displays an avatar representative of a user in a small window. Through text-to-speech technology, the avatar speaks the text as the user types the text being used at a chat window. In particular, the user is able to share their mood, temperament, or disposition with the other user, by having the avatar exhibit facial expressions synchronized with head/shoulder movements representative of the emotional state of the user. In addition, the expressive avatar may serve as a virtual presenter in reading poems or novels, where expressions of emotions are highly desired. While the user may input text (e.g., via a keyboard) in some instances, in other instances the user may provide the input in any other manner (e.g., audibly, etc.).

The terms “expressive avatar” may be used interchangeably with a term “avatar” to define the avatar that is being created herein expressing facial expressions, lip synchronizations, and head/shoulder movements representative of emotional states. The terms “personalized avatar,” meanwhile, refers to the avatar created in the user's image.

While aspects of described techniques can be implemented in any number of different computing systems, environments, and/or configurations, implementations are described in the context of the following illustrative computing environment.

### Illustrative Environment

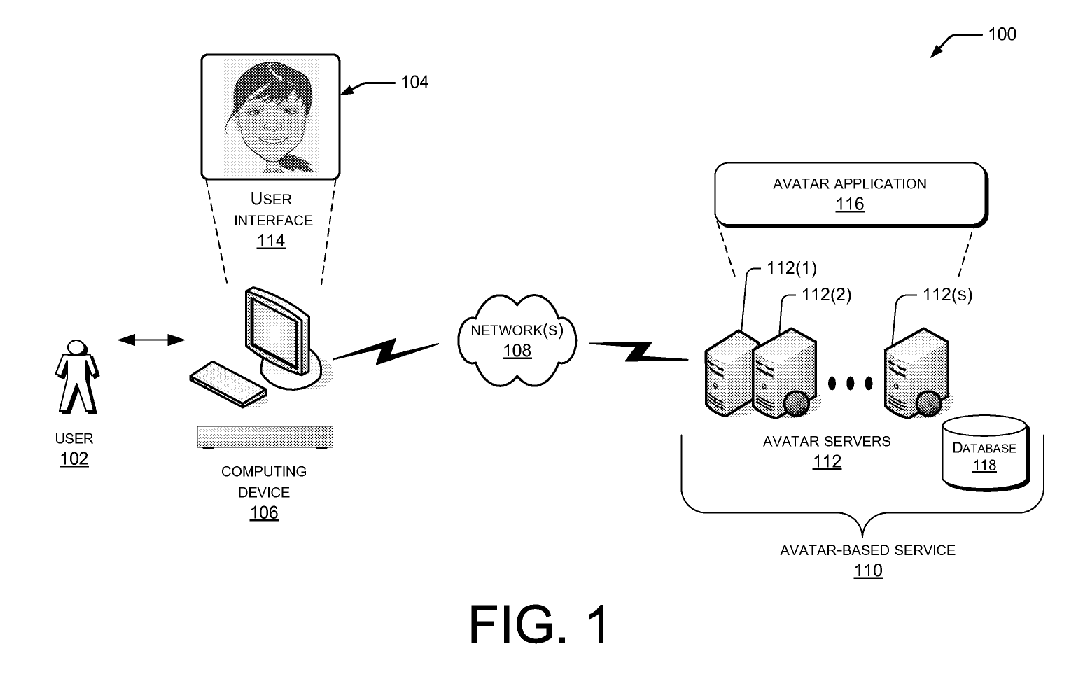

FIG. 1 is a diagram of an illustrative architectural environment 100, which enables a user 102 to provide a representation of himself or herself in the form of an avatar 104. The illustrative architectural environment 100 further enables the user 102 to express emotional states through facial expressions, lip synchronization, and head/shoulder movements through the avatar 104 by inputting text on a computing device 106.

The computing device 106 is illustrated as an example desktop computer. The computing device 106 is configured to connect via one or more network(s) 108 to access an avatar-based service 110. The computing device 106 may take a variety of forms, including, but not limited to, a portable handheld computing device (e.g., a personal digital assistant, a smart phone, a cellular phone), a personal navigation device, a laptop computer, a portable media player, or any other device capable of accessing the avatar-based service 110.

The network(s) 108 represents any type of communications network(s), including wire-based networks (e.g., public switched telephone, cable, and data networks) and wireless networks (e.g., cellular, satellite, WiFi, and Bluetooth).

The avatar-based service 110 represents an application service that may be operated as part of any number of online service providers, such as a social networking site, an instant-messaging site, an online newsroom, a web browser, or the like. In addition, the avatar-based service 110 may include additional modules or may work in conjunction with modules to perform the operations discussed below. In an implementation, the avatar-based service 110 may be executed by servers 112, or by an application for a real-time text-based networked communication system, a real-time voice-based networked communication system, and others.

In the illustrated example, the avatar-based service 110 is hosted on one or more servers, such as server 112(1), 112(2), . . . , 112(S), accessible via the network(s) 108. The servers 112(1)-(S) may be configured as plural independent servers, or as a collection of servers that are configured to perform avatar processing functions accessible by the network(s) 108. The servers 112 may be administered or hosted by a network service provider. The servers 112 may also host and execute an avatar application 116 to and from the computing device 106.

In the illustrated example, the computing device 106 may render a user interface (UI) 114 on a display of the computing device 106. The UI 114 facilitates access to the avatar-based service 110 providing real-time networked communication systems. In one implementation, the UI 114 is a browser-based UI that presents a page received from an avatar application 116. For example, the user 102 employs the UI 114 when submitting text or speech input to an instant-messaging program while also displaying the avatar 104. Furthermore, while the architecture 100 illustrates the avatar application 116 as a network-accessible application, in other instances the computing device 106 may host the avatar application 116.

The avatar application 116 creates and trains an animated model to provide a set of probabilistic motions of one or more body parts for the avatar 104 (e.g., upper body parts, such as head and shoulder, lower body parts, such as legs, etc.). The avatar application 116 may use training data from a variety of sources, such as live input or recorded data. The training data includes receiving speech and motion recordings of actors, to create the model.

The environment 100 may include a database 118, which may be stored on a separate server or the representative set of servers 112 that is accessible via the network(s) 108. The database 118 may store personalized avatars generated by the avatar application 116 and may host the animated models created and trained to be applied when there is speech input.

### Illustrative Processes

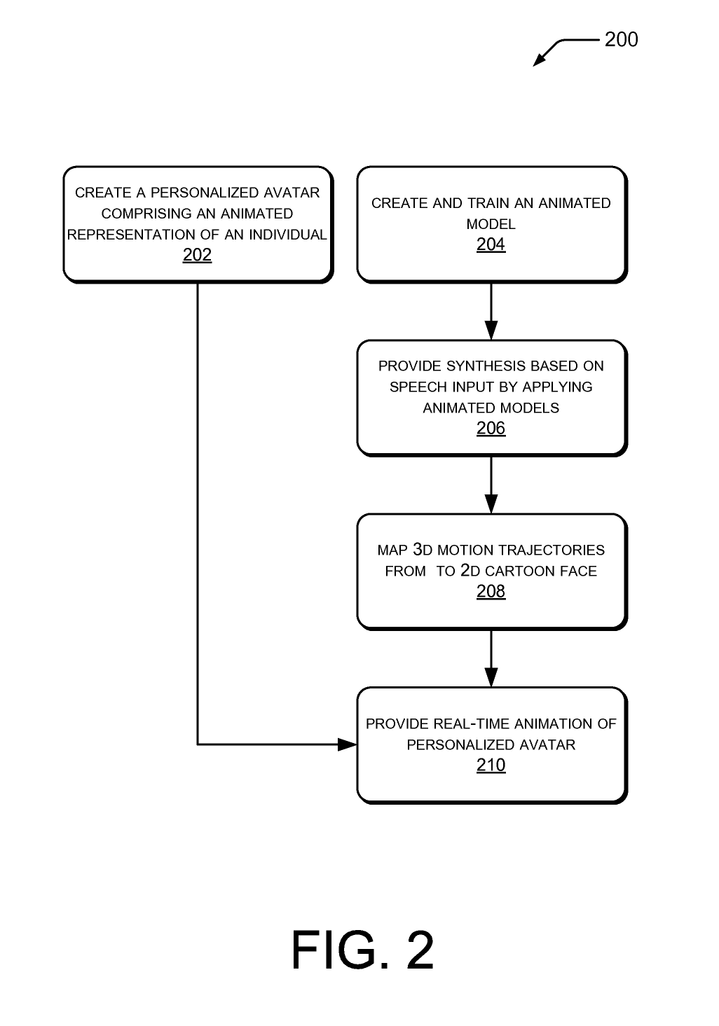

FIGS. 2-4 and 6-7 are flowcharts showing example processes. The processes are illustrated as a collection of blocks in logical flowcharts, which represent a sequence of operations that can be implemented in hardware, software, or a combination. For discussion purposes, the processes are described with reference to the computing environment 100 shown in FIG. 1. However, the processes may be performed using different environments and devices. Moreover, the environments and devices described herein may be used to perform different processes.

For ease of understanding, the methods are delineated as separate steps represented as independent blocks in the figures. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible for one or more of the provided steps to be omitted.

FIG. 2 is a flowchart showing an example process 200 of high-level functions performed by the avatar-based service 110 and/or the avatar application 116. The process 200 may be divided into five phases, an initial phase to create a personalized avatar comprising an animated representation of an individual 202, a second phase to create and train an animated model 204, a third phase to provide animated synthesis based on speech input and the animated model 206, a fourth phase to map 3D motion trajectories to 2D cartoon face 208, and a fifth phase to provide real-time animation of the personalized avatar. All of the phases may be used in the environment of FIG. 1, may be performed separately or in combination, and without any particular order.

The first phase is to create a personalized avatar comprising an animated representation of an individual 202. The avatar application 116 receives input of frontal view images of individual users. Based on the frontal view images, the avatar application 116 automatically generates a cartoon image of an individual.

The second phase is to create and train one or more animated models 204. The avatar application 116 receives speech and motion data of individuals. The avatar application 116 processes speech and observations of patterns, movements, and behaviors from the data to translate to one or more animated models for the different body parts. The predetermined phrases of emotional states are then linked to the animated models.

The third phase is to provide an animated synthesis based on speech input by applying the animated models 206. If the speech input is text, the avatar application 116 performs a text-to-speech synthesis, converting the text into speech. Next, the avatar application 116 identifies motion trajectories for the different body parts from the set of probabilistic motions in response to the speech input. The avatar application 116 uses the motion trajectories to synthesize a sequence of animations, performing a motion trajectory synthesis.

The fourth phase is to map 3D motion trajectories to 2D cartoon face 208. The avatar application 116 builds a 3D model to generate computer facial animation to map to a 2D cartoon face. The 3D model includes groups of motion trajectories and parameters located around certain facial features.

The fifth phase is to provide real-time animation of the personalized avatar 210. This phase includes combining the personalized avatar generated 202 with the mapping of a number of points (e.g., about 92 points, etc.) to the face to generate a 2D cartoon avatar. The 2D cartoon avatar is a low resolution, which allows rendering of this avatar to occur on many computing devices.

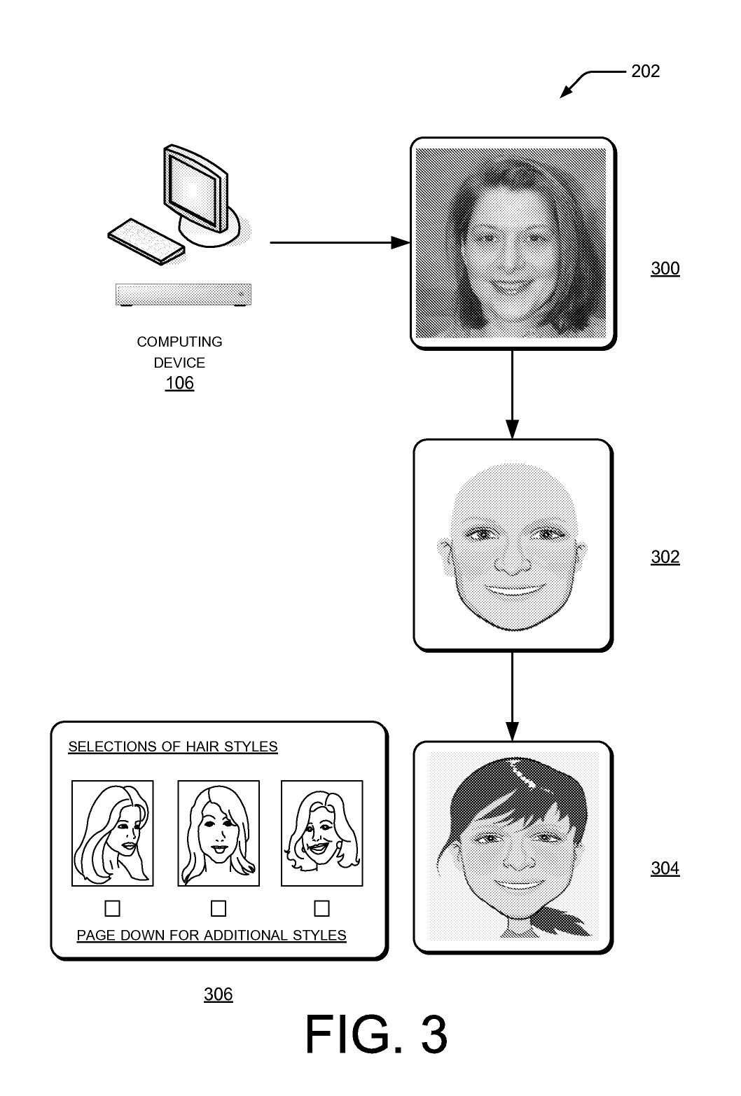

FIG. 3 is a flowchart showing an illustrative process of creating a personalized avatar comprising an animated representation of an individual 202 (discussed at a high level above).

At 300, the avatar application 116 receives a frontal view image of the user 102 as viewed on the computing device 106. Images for the frontal view may start from a top of a head down to a shoulder in some instances, while in other instances these images may include an entire view of a user from head to toe. The images may be photographs or taken from sequences of video, and in color or in black or white. In some instances, the applications for the avatar 104 focus primarily on movements of upper body parts, from the top of the head down to the shoulder. Some possible applications with the upper body parts are to use the personalized avatar 104 as a virtual news anchor, a virtual assistant, a virtual weather person, and as icons in services or programs. Other applications may focus on a larger or different size of avatar, such as a head-to-toe version of the created avatar.

At 302, the avatar application 116 applies Active Shape Model (ASM) and techniques from U.S. Pat. No. 7,039,216, which are incorporated herein for reference, to generate automatically a cartoon image, which then forms the basis for the personalized avatar 104. The cartoon image depicts the user's face as viewed from the frontal view image. The personalized avatar represents dimensions of the user's features as close as possible without any enlargement of any feature. In an implementation, the avatar application 116 may exaggerate certain features of the personalized avatar. For example, the avatar application 116 receives a frontal view image of an individual having a large chin. The avatar application 116 may exaggerate the chin by depicting a large pointed chin based on doubling to tripling the dimensions of the chin. However, the avatar application 116 represents the other features as close to the user's dimensions on the personalized avatar.

At 304, the user 102 may further personalize the avatar 104 by adding a variety of accessories. For example, the user 102 may select from a choice of hair styles, hair colors, glasses, beards, mustaches, tattoos, facial piercing rings, earrings, beauty marks, freckles, and the like. A number of options for each of the different accessories is available for the user to select from, ranging from several to 20.

At 306, the user 102 may choose from a number of hair styles illustrated on a drop down menu or page down for additional styles. The hair styles range from long, to shoulder length, and to chin length in some instances. As shown at 304, the user 102 chooses a ponytail hair style with bangs.

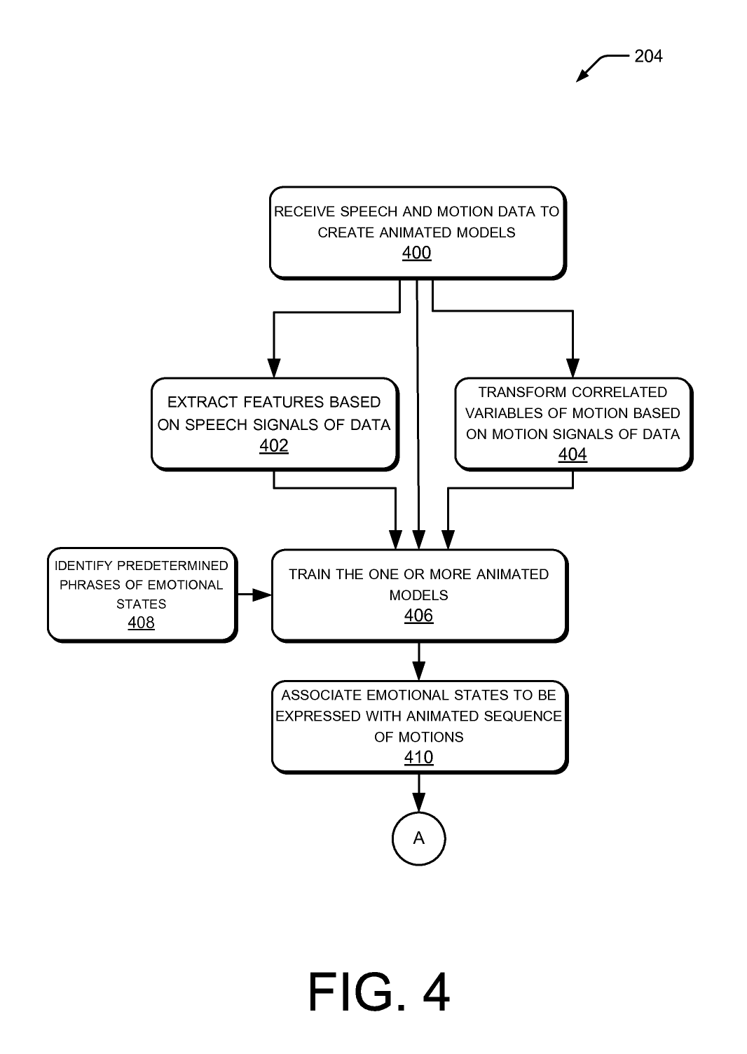

FIG. 4 is a flowchart showing an illustrative process of creating and training animated models 204 (discussed at a high level above).

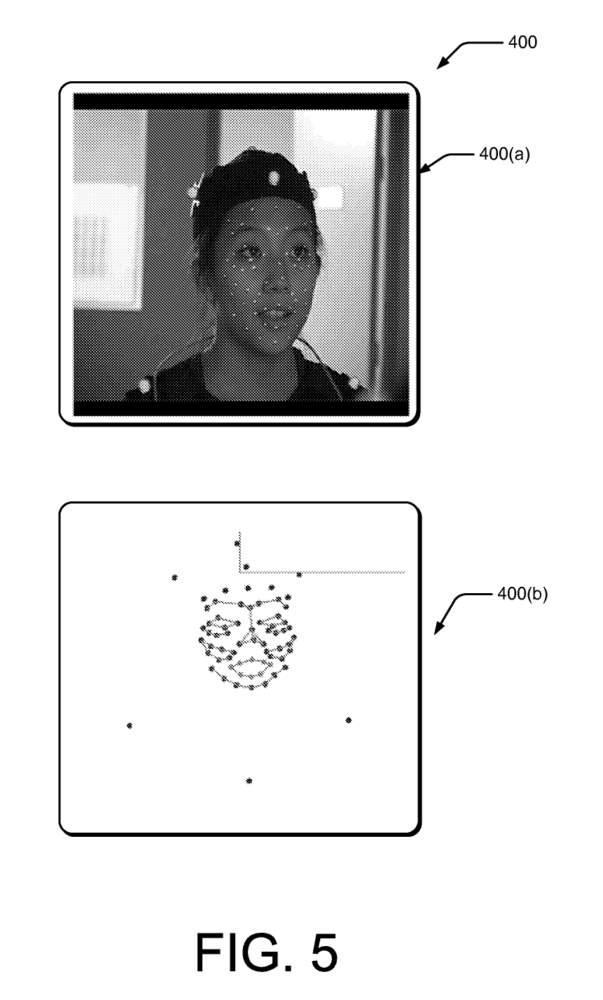

The avatar application 116 receives speech and motion data to create animated models 400. The speech and motion data may be collected using motion capture and/or performance capture, which records movement of the upper body parts and translates the movement onto the animated models. The upper body parts include but are not limited to one or more of overall face, a chin, a mouth, a tongue, a lip, a nose, eyes, eyebrows, a forehead, cheeks, a head, and a shoulder. Each of the different upper body parts may be modeled using same or different observation data. The avatar application 116 creates different animated models for each upper body parts or an animated model for a group of facial features. Turning to the discussion with reference to FIG. 5, which illustrates collecting the speech and motion data for the animated model.

FIG. 5 illustrates an example process 400(a) by attaching special markers to the upper body parts of an actor in a controlled environment. The actor may be reading or speaking from a script with emotional states to be expressed by making facial expressions along with moving their head and shoulders in a manner representative of the emotional states associated with the script. For example, the process may apply and track about 60 or more facial markers to capture facial features when expressing facial expressions. Multiple cameras may record the movement to a computer. The performance capture may use a higher resolution to detect and to track subtle facial expressions, such as small movements of the eyes and lips.

Also, the motion and/or performance capture uses about five or more markers to track movements of the head in some examples. The markers may be placed at a front, sides, a top, and a back of the head. In addition, the motion and/or performance capture uses about three or more shoulder markers to track movements of the shoulder. The markers may be placed on each side of the shoulder and in the back. Implementations of the data include using a live video feed or a recorded video stored in the database 118.

At 400(b), the facial markers may be placed in various groups, such as around a forehead, each eyebrow, each eye, a nose, the lips, a chin, overall face, and the like. The head markers and the shoulder markers are placed on the locations, as discussed above.

The avatar application 116 processes the speech and observations to identify the relationships between the speech, facial expressions, head and shoulder movements. The avatar application 116 uses the relationships to create one or more animated models for the different upper body parts. The animated model may perform similar to a probabilistic trainable model, such as Hidden Markov Models (HMM) or Artificial Neural Networks (ANN). For example, HMMs are often used for modeling as training is automatic and the HMMs are simple and computationally feasible to use. In an implementation, the one or more animated models learn and train from the observations of the speech and motion data to generate probabilistic motions of the upper body parts.

Returning to FIG. 4, at 402, the avatar application 116 extracts features based on speech signals of the data. The avatar application 116 extracts segmented speech phoneme and prosody features from the data. The speech phoneme is further segmented into some or all of the following: individual phones, diphones, half-phones, syllables, morphemes, words, phrases, and sentences to determine speech characteristics. The extraction further includes features such as acoustic parameters of a fundamental frequency (pitch), a duration, a position in the syllable, and neighboring phones. Prosody features refer to a rhythm, a stress, and an intonation of speech. Thus, prosody may reflect various features of a speaker, based on the tone and inflection. In an implementation, the duration information extracted may be used to scale and synchronize motions modeled by the one or more animated models to the real-time speech input. The avatar application 116 uses the extracted features of speech to provide probabilistic motions of the upper body parts.

At 404, the avatar application 116 transforms motion trajectories of the upper body parts to a new coordinate system based on motion signals of the data. In particular, the avatar application 116 transforms a number of possibly correlated motion trajectories of upper body parts into a smaller number of uncorrelated motion trajectories, known as principal components. A first principal component accounts for much of the variability in the motion trajectories, and each succeeding component accounts for the remaining variability of the motion trajectories. The transformation of the trajectories is an eigenvector-based multivariate analysis, to explain the variance in the trajectories. The motion trajectories represent the upper body parts.

At 406, the avatar application 116 trains the one or more animated models by using the extracted features from the speech 402, motion trajectories transformed from the motion data 404, and speech and motion data 400. The avatar application 116 trains the animated models using the extracted features, such as sentences, phrases, words, phonemes, and transformed motion trajectories on a new coordinate motion. In particular, the animated model may generate a set of motion trajectories, referred to as probabilistic motion sequences of the upper body parts based on the extracted features of the speech. The animated model trains by observing and learning the extracted speech synchronized to the motion trajectories of the upper body parts. The avatar application 116 stores the trained animated models in the database 118 to be accessible upon receiving real-time speech input.

At 408, the avatar application 116 identifies predetermined phrases that are often used to represent basic emotional states. Some of the basic emotional states that may be expressed include neutral, happiness, fear, anger, surprise, and sadness. The avatar application 116 links the predetermined phrases with the trained data from the animated model. In an implementation, the avatar application 116 extracts the words, phonemes, and prosody information from the predetermined phrases to identify the sequence of upper body part motions to correspond to the predetermined phrases. For instance, the avatar application 116 identifies certain words in the predetermined phrases that are associated with specific emotions. Words such as “engaged” or “graduated” may be associated with emotional states of happiness.

At 410, the avatar application 116 associates an emotional state to be expressed with an animated sequence of motion of the upper body parts. The animated sequence of motions is from the one or more animated models. The avatar application 116 identifies whether the real-time speech input matches or is close in context to the one or more predetermined phrases (e.g., having a similarity to a predetermined phrase that is greater than a threshold). If there is a match or close in context, the emotional state is expressed through an animated sequence of motions of the upper body parts. The avatar application 116 associates particular facial expressions along with head and shoulder movements to specific emotional states to be expressed in the avatar. “A” represents the one or more animated models of the different upper body parts.

In an implementation, the emotional state to be expressed may be one of happiness. The animated sequence of motion of the upper body parts may include exhibiting a facial expression of wide open eyes or raised eyebrows, lip movements turned up at the corners in a smiling manner, a head nodding or shaking in an up and down movement, and/or shoulders in an upright position to represent body motions of being happy. The one or more predetermined phrases may include “I graduated,” “I am engaged,” “I am pregnant,” and “I got hired.” The happy occasion phrases may be related to milestones of life in some instances.

In another implementation, the emotional state that may also be expressed is sadness. The animated sequence of motion of the upper body parts may include exhibiting facial expressions of eyes looking down, lip movements turned down at the corners in a frown, nostrils flared, the head bowed down, and/or the shoulders in a slouch position, to represent body motions of sadness. One or more predetermined phrases may include “I lost my parent,” “I am getting a divorce,” “I am sick,” and “I have cancer.” The sad occasion phrases tend to be related to disappointments associated with death, illness, divorce, abuse, and the like.

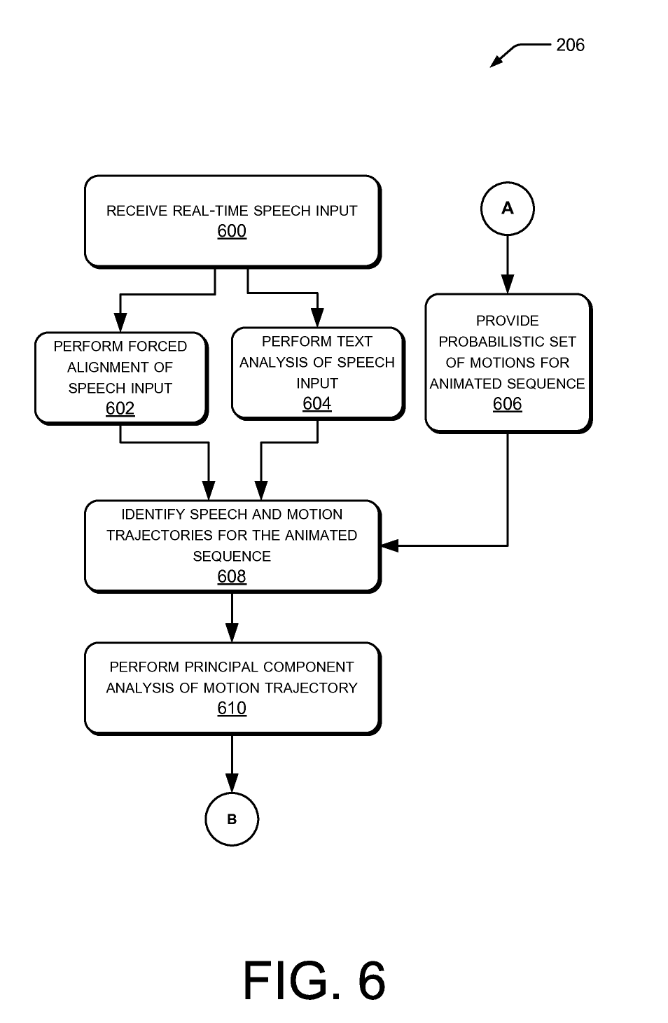

FIG. 6 a flowchart showing an illustrative process of providing animated synthesis based on speech input by applying animated models 206 (discussed at a high level above).

In an implementation, the avatar application 116 or avatar-based service 110 receives real-time speech input 600. Real-time speech input indicates receiving the input to generate a real-time based animated synthesis for facial expressions, lip-synchronization, and head/shoulder movements. The avatar application 116 performs a text-to-speech synthesis if the input is text, converting the text into speech. Qualities of the speech synthesis that are desired are naturalness and intelligibility. Naturalness describes how closely the speech output sounds like human speech, while intelligibility is the ease with which the speech output is understood.

The avatar application 116 performs a forced alignment of the real-time speech input 602. The force alignment causes segmentation of the real-time speech input into some or all of the following: individual phones, diphones, half-phones, syllables, morphemes, words, phrases, and sentences. Typically, a specially modified speech recognizer set may divide the real-time speech input into the segments to a forced alignment mode, using visual representations, such as waveform and spectrogram. Segmented units are identified based on the segmentation and acoustic parameters like a fundamental frequency (i.e., a pitch), a duration, a position in the syllable, and neighboring phones. The duration information extracted from the real-time speech input may scale and synchronize the upper body part motions modeled by the animated model to the real-time speech input. During speech synthesis, a desired speech output may be created by determining a best chain of candidate units from the segmented units.

In an implementation of forced alignment, the avatar application 116 provides an exact transcription of what is being spoken as part of the speech input. The avatar application 116 aligns the transcribed data with speech phoneme and prosody information, and identifies time segments in the speech phoneme and the prosody information corresponding to particular words in transcription data.

The avatar application 116 performs text analysis of the real-time speech input 604. The text analysis may include analyzing a formal, a rhetorical, and logical connections of the real-time speech input and evaluating how the logical connections work together to produce meaning. In another implementation, the analysis involves generating labels to identify parts of the text that correspond to movements of the upper body parts.

At 606, the animated model represented by “A” provides a probabilistic set of motions for an animated sequence of one or more upper body parts. In an implementation, the animated model provides a sequence of HMMs that are stream-dependent.

At 608, the avatar application 116 applies the one or more animated models to identify the speech and corresponding motion trajectories for the animated sequence of one or more upper body parts. The synthesis relies on information from the forced alignment and the text analysis of the real-time speech input to select the speech and corresponding motion trajectories from the one or more animated models. The avatar application 116 uses the identified speech and corresponding motion trajectories to synthesize the animated sequence synchronized with speech output that corresponds to the real-time speech input.

At 610, the avatar application 116 performs principal component analysis (PCA) on the motion trajectory data. PCA compresses a set of high dimensional vectors into a set of lower dimensional vectors to reconstruct an original set. PCA transforms the motion trajectory data to a new coordinate system, such that a greatest variance by any projection of the motion trajectory data comes to lie on a first coordinate (e.g., a first principal component), the second greatest variance on the second coordinate, and so forth. PCA performs a coordinate rotation to align the transformed axes with directions of maximum variance. The observed motion trajectory data has a high signal-to-noise ratio. The principal components with larger variance correspond to more in depth analysis and lower components correspond to noise. Thus, moving a facial feature, such as the lips, will move all related vertices. Shown at “B” is a representation of the motion trajectories used for real-time emotion mapping.

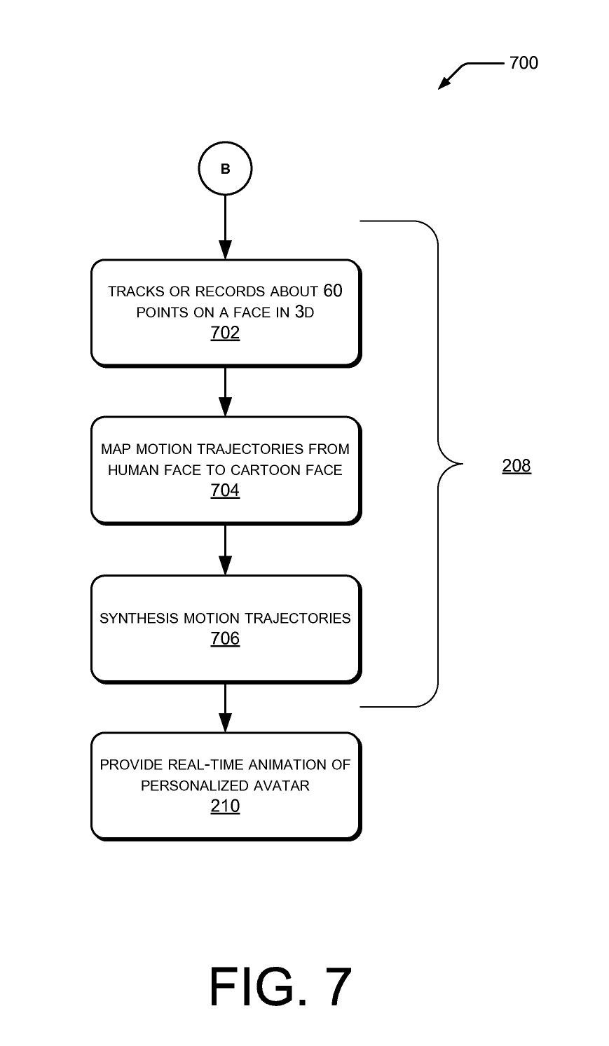

FIG. 7 is a flowchart showing an illustrative process 700 of mapping a 3D motion trajectories to a 2D cartoon face 208 (discussed at a high level) and providing real-time animation of personalized avatar 210 (discussed at a high level).

The avatar application 116 tracks or records movement of about 60 points on a human face in 3D 702. Based on the tracking, the avatar application 116 creates an animated model to evaluate the one or more upper body parts. In an implementation, the avatar application 116 creates a model as discussed for the one or more animated models, indicated by “B.” This occurs by using face motion capture or performance capture, which makes use of facial expressions based on an actor acting out the scenes as if he or she was the character to be animated. His or her upper body parts motion is recorded to a computer using multiple video cameras and about 60 facial markers. The coordinates or relative positions of the about 60 reference points on the human face may be stored in the database 118. Facial motion capture presents challenges of needing higher resolution requirements. The eye and lip movements tend to be small, making it difficult to detect and to track subtle expressions. These movements may be less than a few millimeters, requiring even greater resolution and fidelity along with filtering techniques.

At 704, the avatar application 116 maps motion trajectories from the human face to the cartoon face. The mapping of the cartoon face is provided to the upper body part motions. The model maps about 60 markers of the human face in 3D to about 92 markers of the cartoon face in 2D to create real-time emotion.

At 706, synthesized motion trajectory occurs based on computing the new 2D cartoon facial points. The motion trajectory is provided to ensure that the parameterized 2D or 3D model may synchronize with the real-time speech input.

At 210, the avatar application 116 provides real-time animation of the personalized avatar. The animated sequence of upper body parts are combined with the personalized avatar in response to the real-time speech input. In particular, for 2D cartoon animations, the rendering process is a key frame illustration process. The frames in the 2D cartoon avatar may be rendered in real-time based on the low bandwidth animations transmitted via the Internet. Rendering in real time is an alternative to streaming or pre-loaded high bandwidth animations.

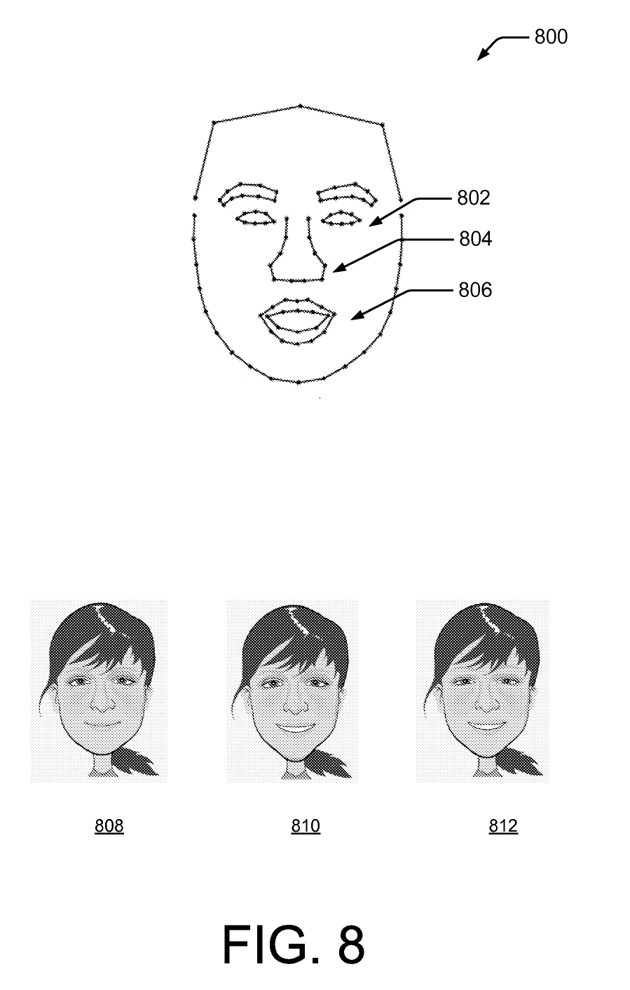

FIG. 8 illustrates an example mapping 800 on a face of about 90 or more points on the face in 2D. The mapping 800 illustrates how the motion trajectories are mapped based on a set of facial features. For example, the avatar application 116 maps the motion trajectories around the eyes 802, around the nose 804, and around the lips/mouth 806. Shown in the lower half of the diagram are emotional states that may be expressed by the avatar. At 808 is a neutral emotional state without expressing any emotions. At 810 and 812, the avatar may be in a happy mood with the facial expressions changing slightly and the lips opening wider. The avatar may display this happy emotional state in response to the application 116 detecting that the user's inputted text matches a predetermined phrase associated with this “happy” emotional state. As such, when the user provides a “happy” input, the avatar correspondingly displays this happy emotional state.

### Illustrative Server Implementation

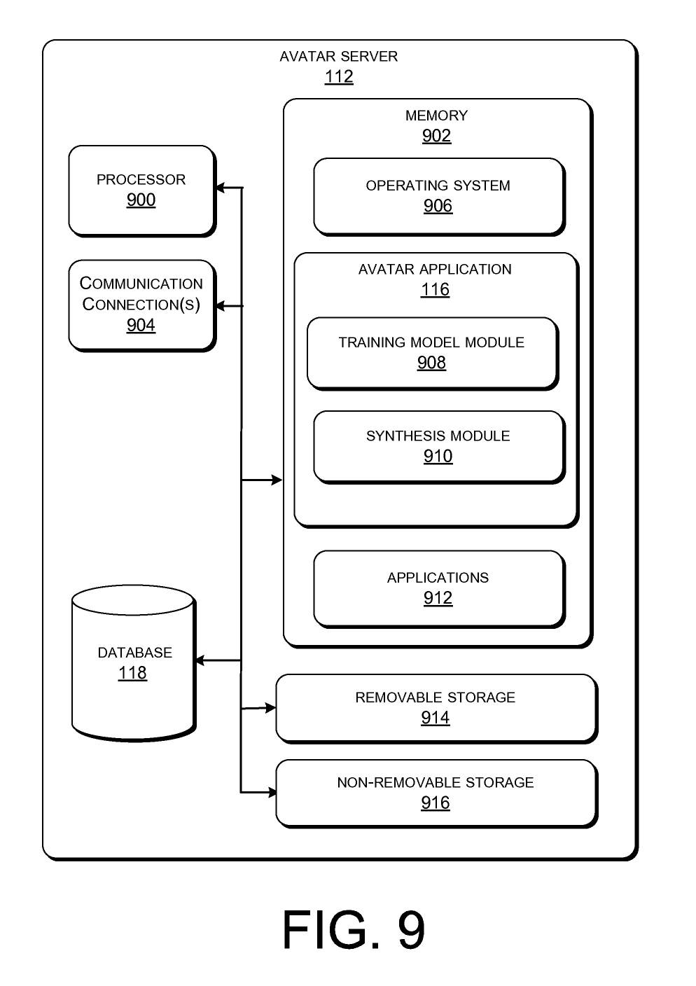

FIG. 9 is a block diagram showing an example server usable with the environment of FIG. 1. The server 112 may be configured as any suitable system capable of services, which includes, but is not limited to, implementing the avatar-based service 110 for online services, such as providing avatars in instant-messaging programs. In one example configuration, the server 114 comprises at least one processor 900, a memory 902, and a communication connection(s) 904. The communication connection(s) 904 may include access to a wide area network (WAN) module, a local area network module (e.g., WiFi), a personal area network module (e.g., Bluetooth), and/or any other suitable communication modules to allow the server 112 to communicate over the network(s) 108.

Turning to the contents of the memory 902 in more detail, the memory 902 may store an operating system 906, and the avatar application 116. The avatar application 116 includes a training model module 908 and a synthesis module 910. Furthermore, there may be one or more applications 912 for implementing all or a part of applications and/or services using the avatar-based service 110.

The avatar application 116 provides access to avatar-based service 110. It receives real-time speech input. The avatar application 116 further provides a display of the application on the user interface, and interacts with the other modules to provide the real-time animation of the avatar in 2D.

The avatar application 116 processes the speech and motion data, extracts features from the synchronous speech, performs PCA transformation, forces alignment of the real-time speech input, and performs text analysis of the real-time speech input along with mapping motion trajectories from the human face to the cartoon face.

The training model module 908 receives the speech and motion data, builds, and trains the animated model. The training model module 908 computes relationships between speech and upper body parts motion by constructing the one or more animated models for the different upper body parts. The training model module 908 provides a set of probabilistic motions of one or more upper body parts based on the speech and motion data, and further associates one or more predetermined phrases of emotional states to the one or more animated models.

The synthesis module 910 synthesizes an animated sequence of motion of upper body parts by applying the animated model in response to the real-time speech input. The synthesis module 910 synthesizes an animated sequence of motions of the one or more upper body parts by selecting from a set of probabilistic motions of the one or more upper body parts. The synthesis module 910 provides an output of speech corresponding to the real-time speech input, and constructs a real-time animation based on the output of speech synchronized to the animation sequence of motions of the one or more upper body parts.

The server 112 may also include or otherwise have access to the database 118 that was previously discussed in FIG. 1

The server 114 may also include additional removable storage 914 and/or non-removable storage 916. Any memory described herein may include volatile memory (such as RAM), nonvolatile memory, removable memory, and/or non-removable memory, implemented in any method or technology for storage of information, such as computer-readable storage media, computer-readable instructions, data structures, applications, program modules, emails, and/or other content. Also, any of the processors described herein may include onboard memory in addition to or instead of the memory shown in the figures. The memory may include storage media such as, but not limited to, random access memory (RAM), read only memory (ROM), flash memory, optical storage, magnetic disk storage or other magnetic storage devices, or any other medium which can be used to store the desired information and which can be accessed by the respective systems and devices.

The server 112 as described above may be implemented in various types of systems or networks. For example, the server 112 may be a part of, including but is not limited to, a client-server system, a peer-to-peer computer network, a distributed network, an enterprise architecture, a local area network, a wide area network, a virtual private network, a storage area network, and the like.

Various instructions, methods, techniques, applications, and modules described herein may be implemented as computer-executable instructions that are executable by one or more computers, servers, or telecommunication devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method implemented at least partially by a processor, the method comprising:
training one or more animated models to provide a set of probabilistic motions for one or more upper body parts of an avatar based at least in part on speech and motion data;
associating one or more predetermined phrases of emotional states with the one or more animated models;
receiving real-time speech input;
identifying an emotional state to be expressed based at least in part on the one or more predetermined phrases matching at least a portion of the real-time speech input; and
generating an animated sequence of motions of the one or more upper body parts of the avatar by applying the one or more animated models in response to the real-time speech input, the animated sequence of motions expressing the identified emotional state.

2. The method of claim 1, further comprising;
receiving a frontal view image of an individual; and
creating a representation of the individual from the frontal view image to generate the avatar.

3. The method of claim 1, further comprising:
providing an output of speech corresponding to the real-time speech input; and
constructing a real-time animation of the avatar based at least in part on the output of speech synchronized to the animation sequence of motions of the one or more upper body parts.

4. The method of claim 1, further comprising forcing alignment of the real-time speech input based at least in part on:
providing a transcription of what is being spoken as part of the real-time speech input;
aligning the transcription with speech phoneme and prosody information; and
identifying time segments in the speech phoneme and the prosody information corresponding to particular words in the transcription.

5. The method of claim 1, further comprising forcing alignment of the real-time speech input data based at least in part on:
segmenting the real-time speech input into at least one of the following:
individual phones, diphones, half-phones, syllables, morphemes, words, phrases, or sentences; and
dividing the real-time speech input into the segments to a forced alignment mode based at least in part on visual representations of a waveform and a spectrogram.

6. The method of claim 1, further comprising analyzing text of the real-time speech input based at least in part on:
analyzing logical connections of the real-time speech input; and
identifying the logical connections that work together to produce context of the real-time speech input.

7. The method of claim 1, further comprising:
segmenting speech of the speech and motion data;
extracting speech phoneme and prosody information from the segmented speech; and
transforming motion trajectories from the speech and motion data to a new coordinate system.

8. The method of claim 1, wherein the one or more upper body parts include one or more of an overall face, an ear, a chin, a mouth, a lip, a nose, eyes, eyebrows, a forehead, cheeks, a neck, a head, and shoulders.

9. The method of claim 1, wherein the emotional states include at least one of neutral, happiness, sadness, surprise, or anger.

10. The method of claim 1, wherein training of the one or more animated models to provide the probabilistic motions for the one or more upper body parts include tracking movement of about sixty or more facial positions, about five or more head positions, and about three or more shoulder positions.

11. One or more computer-readable storage media encoded with instructions that, when executed by a processor, perform acts comprising:
creating one or more animated models to provide a set of probabilistic motions for one or more upper body parts of an avatar based at least in part on speech and motion data; and
associating one or more predetermined phrases representing respective emotional states to the one or more animated models.

12. The computer-readable storage media of claim 11, further comprising:
training the one or more animated models based using Hidden Markov Model (HMM) techniques.

13. The computer-readable storage media of claim 11, further comprising:
receiving real-time speech input;
identifying an emotional state to be expressed based at least in part on the one or more predetermined phrases matching at least a portion of the real-time speech input; and
generating an animated sequence of motions of the one or more upper body parts of the avatar by applying the one or more animated models in response to the real-time speech input, the animated sequence of motions expressing the identified emotional state.

14. The computer-readable storage media of claim 11, further comprising:
receiving real-time speech input;
providing a transcription of what is being spoken as part of the real-time speech input;
aligning the transcription with speech phoneme and prosody information; and
identifying time segments in the speech phoneme and the prosody information corresponding to particular words in the transcription.

15. The computer-readable storage media of claim 11, further comprising:
receiving real-time speech input;
analyzing logical connections of the real-time speech input; and
determining how the logical connections work together to produce a context.

16. The computer-readable storage media of claim 11, further comprising:
receiving a frontal view image of an individual;
generating the avatar based at least in part on the frontal view image; and
receiving a selection of accessories for the generated avatar.

17. The computer-readable storage media of claim 11, wherein the creating of the one or more animated models to provide the set of probabilistic motions for the one or more upper body parts includes tracking movement of about sixty or more facial positions, tracking about five or more head positions, and tracking about three or more shoulder positions.

18. A system comprising:
a processor;
memory, communicatively coupled to the processor;
a training model module, stored in the memory and executable on the processor, to:
construct one or more animated models by computing relationships between speech and upper body parts motion, the one or more animated models to provide a set of probabilistic motions of one or more upper body parts based at least in part on inputted speech and motion data; and
associate one or more predetermined phrases of emotional states to the one or more animated models.

19. A system of claim 18, comprising a synthesis module, stored in the memory and executable on the processor, to synthesize an animated sequence of motions of the one or more upper body parts by selecting motions from the set of probabilistic motions of the one or more upper body parts.

20. A system of claim 19, comprising a synthesis module, stored in the memory and executable on the processor, to:
receive real-time speech input;
provide an output of speech corresponding to the real-time speech input; and
construct a real-time animation based at least in part on the output of speech synchronized to the animated sequence of motions of the one or more upper body parts.
